(19) United States
(12) Patent Application Publication
(10) Pub. No.: US 2015/0193098 A1
(43) Pub. Date: Jul. 9, 2015

(54) Yes or No User-Interface

(71) Applicants: Alejandro Kauffmann, San Francisco, CA (US); Hayes Solos Raffle, Palo Alto, CA (US); Aaron Joseph Wheeler, San Francisco, CA (US); Luis Ricardo Prada Gomez, Hayward, CA (US); Steven John Lee, San Francisco, CA (US)

(72) Inventors: Alejandro Kauffmann, San Francisco, CA (US); Hayes Solos Raffle, Palo Alto, CA (US); Aaron Joseph Wheeler, San Francisco, CA (US); Luis Ricardo Prada Gomez, Hayward, CA (US); Steven John Lee, San Francisco, CA (US)

(73) Assignee: GOOGLE INC., Mountain View, CA (US)

(21) Appl. No.: 13/428,392

(22) Filed: Mar. 23, 2012

(51) Int. Cl. G06F 3/0484; G06F 3/16; G06F 3/00; G02B 27/01; G06F 3/01; G06F 3/0482

(52) U.S. Cl. CPC G06F 3/0484; G06F 3/0482; G06F 3/041; G06F 3/005; G02B 27/017; G06F 3/167; G02B 2027/0178

(57) ABSTRACT

Methods and systems disclosed herein relate to an action that could proceed or be dismissed in response to an affirmative or negative input, respectively. An example method could include displaying, using a head-mountable device, a graphical interface that presents a graphical representation of an action. The action could relate to at least one of a contact, a contact's avatar, a media file, a digital file, a notification, and an incoming communication. The example method could further include receiving a binary selection from among an affirmative input and a negative input. The example method may additionally include proceeding with the action in response to the binary selection being the affirmative input and dismissing the action in response to the binary selection being the negative input.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called a head-mountable device or a “head-mounted display”. A head-mountable device places a graphic display or displays close to one or both eyes of a wearer. To generate the images on a display, a computer processing system may be used. Such displays may occupy a wearer's entire field of view, or only occupy part of wearer's field of view. Further, head-mountable devices may be as small as a pair of glasses or as large as a helmet.

### SUMMARY

In a first aspect, a method is provided. The method includes displaying, on a head-mountable device, a graphical interface that presents a graphical representation of a first action. The first action relates to at least one of a contact, a contact's avatar, a media file, a digital file, a notification, and an incoming communication. The method also includes receiving a first binary selection from among an affirmative input and a negative input. The method additionally includes proceeding with the first action in response to the first binary selection being the affirmative input. The method further includes dismissing the first action in response to the first binary selection being the negative input.

In a second aspect, a head-mountable device is provided. The head-mountable device includes a display and a controller. The display is configured to display a graphical interface that presents a graphical representation of an action. The action relates to at least one of a contact, a contact's avatar, a media file, a digital file, a notification, and an incoming communication. The controller is configured to: a) receive a binary selection from among an affirmative input and a negative input; b) proceed with the action in response to the binary selection being the affirmative input; and c) dismiss the action in response to the binary selection being the negative input.

In a third aspect, a non-transitory computer readable medium having stored instructions is provided. The instructions are executable by a computer system to cause the computer system to perform functions. The functions include displaying, on a head-mountable device, a graphical interface that presents a graphical representation of an action. The action relates to at least one of a contact, a contact's avatar, a media file, a digital file, a notification, and an incoming communication. The functions further include receiving a binary selection from among an affirmative input and a negative input. The functions additionally include proceeding with the action in response to the binary selection being the affirmative input. The functions yet further include dismissing the action in response to the binary selection being the negative input.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A illustrates a head-mountable device according to an example embodiment.

FIG. 1B illustrates an alternate view of the head-mountable device illustrated in

FIG. 1A.

FIG. 1C illustrates another head-mountable device according to an example embodiment.

FIG. 1D illustrates another head-mountable device according to an example embodiment.

FIG. 2 illustrates a schematic drawing of a computing device according to an example embodiment.

FIG. 3 illustrates a simplified block drawing of a head-mountable device according to an example embodiment.

FIG. 4A illustrates a message notification scenario, according to an example embodiment.

FIG. 4B illustrates a message notification scenario, according to an example embodiment.

FIG. 4C illustrates a message notification scenario, according to an example embodiment.

FIG. 5A illustrates a content creation scenario, according to an example embodiment.

FIG. 5B illustrates a content creation scenario, according to an example embodiment.

FIG. 5C illustrates a content creation scenario, according to an example embodiment.

FIG. 5D illustrates a content creation scenario, according to an example embodiment.

FIG. 5E illustrates a content creation scenario, according to an example embodiment.

FIG. 5F illustrates a content creation scenario, according to an example embodiment.

FIG. 5G illustrates a content creation scenario, according to an example embodiment.

FIG. 6 is a method, according to an example embodiment.

FIG. 7 is a schematic diagram of a computer program product, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

### 1. Overview

Example embodiments disclosed herein relate to displaying, using a head-mountable device, a graphical interface and graphical representation of an action. In response to an affirmative or negative input, the action could proceed or be dismissed, respectively. In example embodiments, the action could relate to at least one of a contact, a contact's avatar, a media file, a digital file, a notification, and an incoming communication. However, other types of actions are possible.

Some methods disclosed herein could be carried out in part or in full by a head-mountable device. In one such example, a graphical interface could be displayed on the head-mountable device. The graphical interface could present a graphical representation of the action. The method may further include receiving a binary selection from among an affirmative input and a negative input. In response to the binary selection being the affirmative input, the action could proceed. In response to the binary selection being the negative input, the action could be dismissed.

The affirmative input and the negative input could be represented in a variety of ways. For example, an affirmative input could include a single-finger interaction on a touchpad of the head-mountable device and a negative input could include a double-finger interaction on the touchpad. Affirmative and/or negative inputs could be additionally or alternatively represented by a rotation of the head-mountable device, an interaction with a button, a gaze axis, a staring gaze, and a voice command, among other possibilities.

In response to the binary selection being the affirmative input, the action may proceed in various ways. For example, the action could be carried out to include capturing an image or an audio recording. In other embodiments, the action could proceed and include navigating a menu or otherwise navigating the graphical interface.

In response to the binary selection being the negative input, the action may be dismissed in various ways. For instance, the action could be dismissed by returning the graphical interface to a default state, such as a blank screen. In other examples, the action could be dismissed by going back to a previous state of the graphical interface.

Other methods disclosed herein could be carried out in part of in full by a server. In an example embodiment, a server may transmit, to a head-mountable device, a graphical interface that presents a graphical representation of an action. In turn, the head-mountable device may display the graphical interface. The head-mountable display may include sensors that are configured to acquire data from various input means. The data could be communicated to the server. Based on the data, the server may determine a binary selection from among the affirmative input and the negative input.

The server may proceed with the action in response to the binary selection being the affirmative input and the server may dismiss the action in response to the binary selection being the negative input. Other interactions between a head-mountable device and a server are possible within the context of the disclosure.

A head-mountable device is also described herein. The head-mountable device could include elements such as a display and a controller. The display could be configured to display a graphical interface that presents a graphical representation of an action. In example embodiments, the action could relate to at least one an audio recording, an image, a video, a calendar notification, and an incoming communication. However, other types of actions are possible.

The controller could be configured to receive a binary selection from among an affirmative input and a negative input. The binary selection could be a single-finger interaction on a touchpad of the head-mountable device, which may be associated with the affirmative input.

A double-finger interaction on the touchpad of the head-mountable device could represent the negative input. Affirmative and negative inputs could take other forms as well, and may include gestures, eye blinks, voice commands, and button interactions, among other possible input methods.

The controller could also be configured to proceed with the action in response to the binary selection being the affirmative input. For instance, proceeding with the action could include carrying out an audio recording, a video recording, creating a calendar event, and responding to an incoming communication. Other ways to proceed with the action are possible.

Additionally, the controller may be configured to dismiss the action in response to the binary selection being the negative input. For example, a user of the head-mountable device could wish to ignore an incoming communication. In such a case, the binary selection could be the negative input and the incoming communication could be dismissed. Other ways to dismiss the action are possible.

Also disclosed herein are non-transitory computer readable media with stored instructions. The instructions could be executable by a computing device to cause the computing device to perform functions similar to those described in the aforementioned methods.

Those skilled in the art will understand that there are many different specific methods and systems that could be used in displaying, on a head-mountable device, a graphical interface that presents a graphical representation of an action, receiving a binary selection from among an affirmative input and a negative input, proceeding with the action in response to the binary selection being the affirmative input, and dismissing the action in response to the binary selection being the negative input. Each of these specific methods and systems are contemplated herein, and several example embodiments are described below.

### 2. Example Systems

Systems and devices in which example embodiments may be implemented will now be described in greater detail. In general, an example system may be implemented in or may take the form of a wearable computer. However, an example system may also be implemented in or take the form of other devices, such as a mobile phone, among others. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

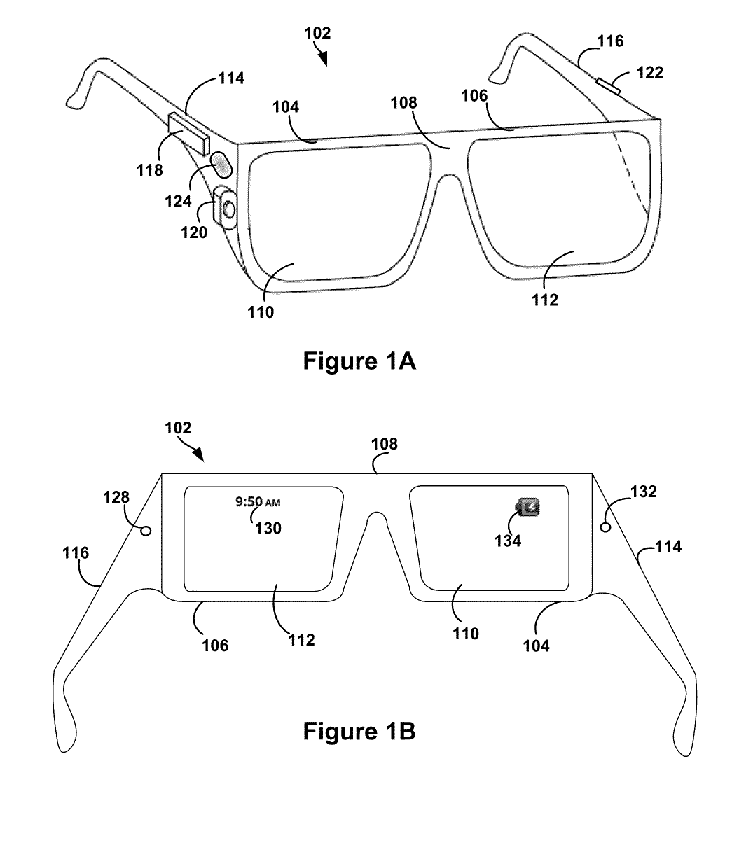

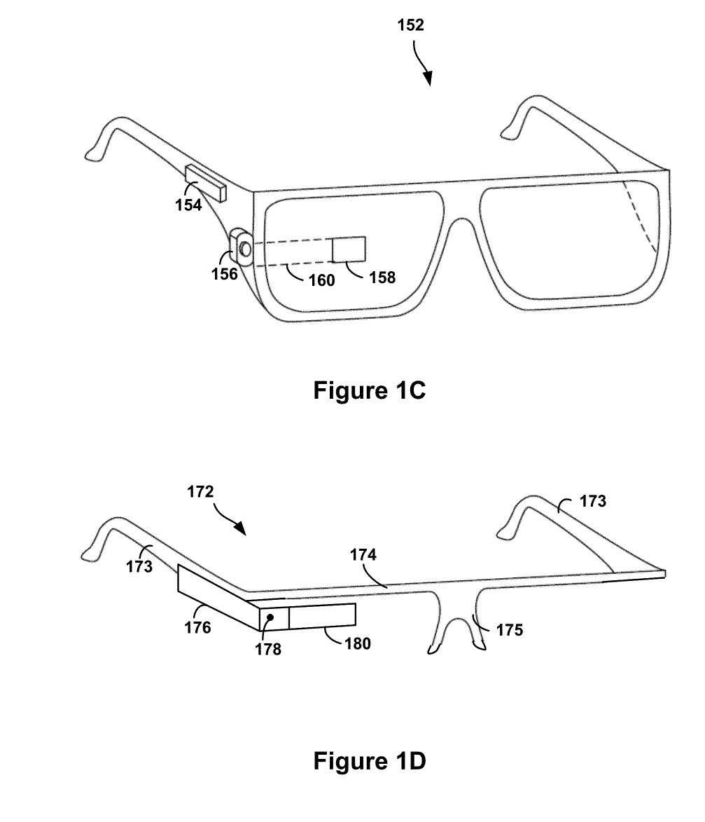

FIG. 1A illustrates a head-mountable device (HMD) 102 (which may also be referred to as a head-mounted display). In some implementations, HMD 102 could function as a wearable computing device. It should be understood, however, that example systems and devices may take the form of or be implemented within or in association with other types of devices, without departing from the scope of the invention. Further, unless specifically noted, it will be understood that the systems, devices, and methods disclosed herein are not functionally limited by whether or not the head-mountable device 102 is being worn. As illustrated in FIG. 1A, the head-mountable device 102 comprises frame elements including lens-frames 104, 106 and a center frame support 108, lens elements 110, 112, and extending side-arms 114, 116. The center frame support 108 and the extending side-arms 114, 116 are configured to secure the head-mountable device 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the head-mountable device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the head-mountable device 102 to the user. The extending side-arms 114, 116 may further secure the head-mountable device 102 to the user by extending around a rear portion of the user's head. Additionally or alternatively, for example, the HMD 102 may connect to or be affixed within a head-mountable helmet structure. Other possibilities exist as well.

The HMD 102 may also include an on-board computing system 118, a video camera 120, a sensor 122, and a finger-operable touchpad 124. The on-board computing system 118 is shown to be positioned on the extending side-arm 114 of the head-mountable device 102; however, the on-board computing system 118 may be provided on other parts of the head-mountable device 102 or may be positioned remote from the head-mountable device 102 (e.g., the on-board computing system 118 could be wire- or wirelessly-connected to the head-mountable device 102). The on-board computing system 118 may include a controller and memory, for example. The on-board computing system 118 may be configured to receive and analyze data from the video camera 120 and the finger-operable touchpad 124 (and possibly from other sensory devices, user interfaces, or both) and generate images for output by the lens elements 110 and 112.

The video camera 120 is shown positioned on the extending side-arm 114 of the head-mountable device 102; however, the video camera 120 may be provided on other parts of the head-mountable device 102. The video camera 120 may be configured to capture images at various resolutions or at different frame rates. Many video cameras with a small form-factor, such as those used in cell phones or webcams, for example, may be incorporated into an example of the HMD 102.

Further, although Figure lA illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with and/or overlay onto the real-world view perceived by the user.

The sensor 122 is shown on the extending side-arm 116 of the head-mountable device 102; however, the sensor 122 may be positioned on other parts of the head-mountable device 102. The sensor 122 may include one or more of a gyroscope or an accelerometer, for example. Other sensing devices may be included within, or in addition to, the sensor 122 or other sensing functions may be performed by the sensor 122.

The finger-operable touchpad 124 is shown on the extending side-arm 114 of the head-mountable device 102. However, the finger-operable touchpad 124 may be positioned on other parts of the head-mountable device 102. Also, more than one finger-operable touchpad may be present on the head-mountable device 102. The finger-operable touchpad 124 may be used by a user to input commands. The finger-operable touchpad 124 may sense at least one of a position and a movement of a finger via capacitive sensing, resistance sensing, or a surface acoustic wave process, among other possibilities. The finger-operable touchpad 124 may be capable of sensing finger movement in a direction parallel or planar to the pad surface, in a direction normal to the pad surface, or both, and may also be capable of sensing a level of pressure applied to the pad surface. The finger-operable touchpad 124 may be formed of one or more translucent or transparent insulating layers and one or more translucent or transparent conducting layers. Edges of the finger-operable touchpad 124 may be formed to have a raised, indented, or roughened surface, so as to provide tactile feedback to a user when the user's finger reaches the edge, or other area, of the finger-operable touchpad 124. If more than one finger-operable touchpad is present, each finger-operable touchpad may be operated independently, and may provide a different function.

FIG. 1B illustrates an alternate view of the head-mountable device illustrated in FIG. 1A. As shown in FIG. 1B, the lens elements 110, 112 may act as display elements. The head-mountable device 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another head-mountable device according to an example embodiment, which takes the form of an HMD 152. The HMD 152 may include frame elements and side-arms such as those described with respect to FIGS. 1A and 1B. The HMD 152 may additionally include an on-board computing system 154 and a video camera 156, such as those described with respect to FIGS. 1A and 1B. The video camera 156 is shown mounted on a frame of the HMD 152. However, the video camera 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions. The display 158 is controllable via the computing system 154 that is coupled to the display 158 via an optical waveguide 160.

FIG. 1D illustrates another head-mountable device according to an example embodiment, which takes the form of an HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include an on-board computing system 176 and a video camera 178, such as those described with respect to FIGS. 1A and 1B.

The HMD 172 may include a single lens element 180 that may be coupled to one of the side-arms 173 or the center frame support 174. The lens element 180 may include a display such as the display described with reference to FIGS. 1A and 1B, and may be configured to overlay computer-generated graphics upon the user's view of the physical world. In one example, the single lens element 180 may be coupled to the inner side (i.e., the side exposed to a portion of a user's head when worn by the user) of the extending side-arm 173. The single lens element 180 may be positioned in front of or proximate to a user's eye when the HMD 172 is worn by a user. For example, the single lens element 180 may be positioned below the center frame support 174, as shown in FIG. 1D.

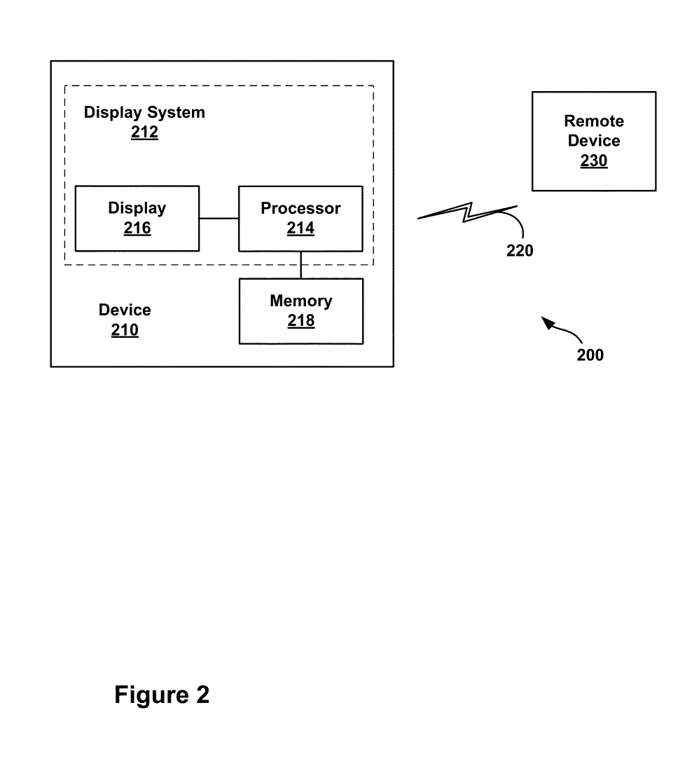

FIG. 2 illustrates a schematic drawing of a computing device according to an example embodiment. In system 200, a device 210 communicates using a communication link 220 (e.g., a wired or wireless connection) to a remote device 230. The device 210 may be any type of device that can receive data and display information corresponding to or associated with the data. For example, the device 210 may be a head-mountable display system, such as the head-mountable devices 102, 152, or 172 described with reference to FIGS. 1A-1D.

Thus, the device 210 may include a display system 212 comprising a processor 214 and a display 216. The display 210 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, or tablet computing device, etc., that is configured to transmit data to the device 210. The remote device 230 and the device 210 may contain hardware to enable the communication link 220, such as processors, transmitters, receivers, antennas, etc.

In FIG. 2, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

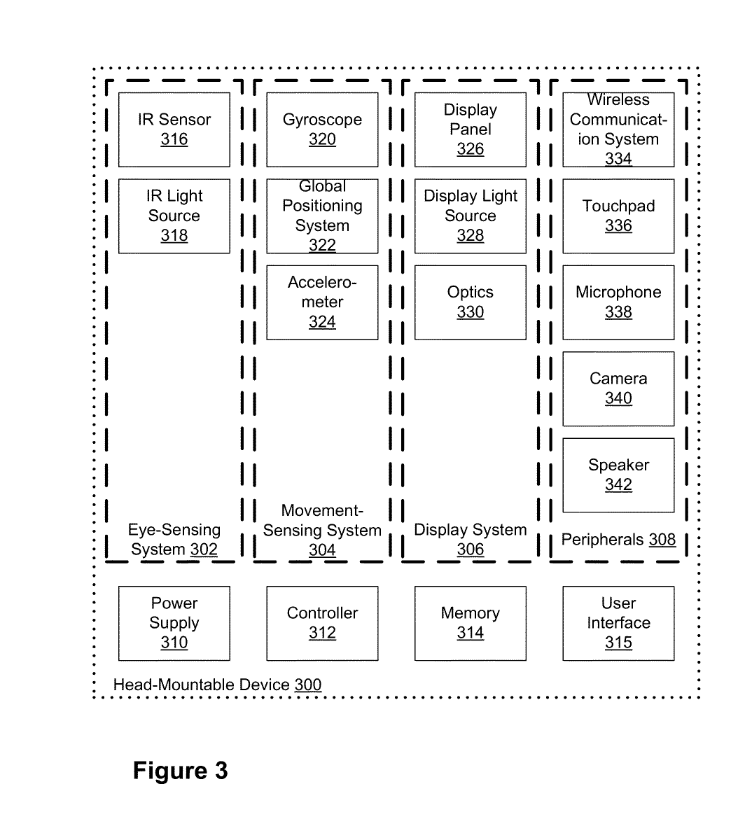

FIG. 3 is a simplified block diagram of a head-mountable device (HMD) 300 that may include several different components and subsystems. HMD 300 could correspond to any of the devices shown and described in reference to FIGS. 1A-1D and FIG. 2. As shown, the HMD 300 includes an eye-sensing system 302, a movement-sensing system 304, an optical system 306, peripherals 308, a power supply 310, a controller 312, a memory 314, and a user interface 315. The eye-sensing system 302 may include hardware such as an infrared sensor 316 and at least one infrared light source 318. The movement-sensing system 304 may include a gyroscope 320, a global positioning system (GPS) 322, and an accelerometer 324. The optical system 306 may include, in one embodiment, a display panel 326, a display light source 328, and optics 330. The peripherals 308 may include a wireless communication system 334, a touchpad 336, a microphone 338, a camera 340, and a speaker 342.

In an example embodiment, HMD 300 includes a see-through display. Thus, the wearer of HMD 300 may observe a portion of the real-world environment, i.e., in a particular field of view provided by the optical system 306. In the example embodiment, HMD 300 is operable to display images that are superimposed on the field of view, for example, to provide an “augmented reality” experience. Some of the images displayed by HMD 300 may be superimposed over particular objects in the field of view. HMD 300 may also display images that appear to hover within the field of view instead of being associated with particular objects in the field of view.

HMD 300 could be configured as, for example, eyeglasses, goggles, a helmet, a hat, a visor, a headband, or in some other form that can be supported on or from the wearer's head. Further, HMD 300 may be configured to display images to both of the wearer's eyes, for example, using two see-through displays. Alternatively, HMD 300 may include only a single see-through display and may display images to only one of the wearer's eyes, either the left eye or the right eye.

The HMD 300 may also represent an opaque display configured to display images to one or both of the wearer's eyes without a view of the real-world environment. For instance, an opaque display or displays could provide images to both of the wearer's eyes such that the wearer could experience a virtual reality version of the real world. Alternatively, the HMD wearer may experience an abstract virtual reality environment that could be substantially or completely detached from the real world. Further, the HMD 300 could provide an opaque display for a first eye of the wearer as well as provide a view of the real-world environment for a second eye of the wearer.

A power supply 310 may provide power to various HMD components and could represent, for example, a rechargeable lithium-ion battery. Various other power supply materials and types known in the art are possible.

The functioning of the HMD 300 may be controlled by a controller 312 (which could include a processor) that executes instructions stored in a non-transitory computer readable medium, such as the memory 314. Thus, the controller 312 in combination with instructions stored in the memory 314 may function to control some or all of the functions of HMD 300. As such, the controller 312 may control the user interface 315 to adjust the images displayed by HMD 300. The controller 312 may also control the wireless communication system 334 and various other components of the HMD 300. The controller 312 may additionally represent a plurality of computing devices that may serve to control individual components or subsystems of the HMD 300 in a distributed fashion.

In addition to instructions that may be executed by the controller 312, the memory 314 may store data that may include a set of calibrated wearer eye pupil positions and a collection of past eye pupil positions. Thus, the memory 314 may function as a database of information related to gaze axis and/or HMD wearer eye location. Such information may be used by HMD 300 to anticipate where the wearer will look and determine what images are to be displayed to the wearer. Within the context of the invention, eye pupil positions could also be recorded relating to a ‘normal’ or a ‘calibrated’ viewing position. Eye box or other image area adjustment could occur if the eye pupil is detected to be at a location other than these viewing positions.

In addition, information may be stored in the memory 314 regarding possible control instructions (e.g., binary selections, and menu selections, among other possibilities) that may be enacted using eye movements. For instance, two consecutive wearer eye blinks may represent a binary selection being a negative input. Another possible embodiment may include a configuration such that specific eye movements may represent a control instruction. For example, an HMD wearer may provide a binary selection as being a positive and/or a negative input with a series of predetermined eye movements.

Control instructions could be based on dwell-based selection of a target object. For instance, if a wearer fixates visually upon a particular image or real-world object for longer than a predetermined time period, a control instruction may be generated to select the image or real-world object as a target object. Many other control instructions are possible.

The HMD 300 may include a user interface 315 for providing information to the wearer or receiving input from the wearer. The user interface 315 could be associated with, for example, the displayed images and/or one or more input devices in peripherals 308, such as touchpad 336 or microphone 338. The controller 312 may control the functioning of the HMD 300 based on inputs received through the user interface 315. For example, the controller 312 may utilize user input from the user interface 315 to control how the HMD 300 displays images within a field of view or to determine what images the HMD 300 displays.

An eye-sensing system 302 may be included in the HMD 300. In an example embodiment, an eye-sensing system 302 may deliver information to the controller 312 regarding the eye position of a wearer of the HMD 300. The eye-sensing data could be used, for instance, to determine a direction in which the HMD wearer may be gazing. The controller 312 could determine target objects among the displayed images based on information from the eye-sensing system 302. The controller 312 may control the user interface 315 and the display panel 326 to adjust the target object and/or other displayed images in various ways. For instance, an HMD wearer could interact with a mobile-type menu-driven user interface using eye gaze movements. Alternatively, the HMD wearer may interact with a user interface having substantially binary (e.g., ‘yes’ or ‘no’) decisions, as illustrated and described herein.

The infrared (IR) sensor 316 may be utilized by the eye-sensing system 302, for example, to capture images of a viewing location associated with the HMD 300. Thus, the IR sensor 316 may image the eye of an HMD wearer that may be located at the viewing location. The images could be either video images or still images. The images obtained by the IR sensor 316 regarding the HMD wearer's eye may help determine where the wearer is looking within the HMD field of view, for instance by allowing the controller 312 to ascertain the location of the HMD wearer's eye pupil. Analysis of the images obtained by the IR sensor 316 could be performed by the controller 312 in conjunction with the memory 314 to determine, for example, a gaze axis.

The imaging of the viewing location could occur continuously or at discrete times depending upon, for instance, HMD wearer interactions with the user interface 315 and/or the state of the infrared light source 318 which may serve to illuminate the viewing location. The IR sensor 316 could be integrated into the optical system 306 or mounted on the HMD 300. Alternatively, the IR sensor 316 could be positioned apart from the HMD 300 altogether. The IR sensor 316 could be configured to image primarily in the infrared. The IR sensor 316 could additionally represent a conventional visible light camera with sensing capabilities in the infrared wavelengths. Imaging in other wavelength ranges is possible.

The infrared light source 318 could represent one or more infrared light-emitting diodes (LEDs) or infrared laser diodes that may illuminate a viewing location. One or both eyes of a wearer of the HMD 300 may be illuminated by the infrared light source 318.

The eye-sensing system 302 could be configured to acquire images of glint reflections from the outer surface of the cornea, (e.g., the first Purkinje images and/or other characteristic glints). Alternatively, the eye-sensing system 302 could be configured to acquire images of reflections from the inner, posterior surface of the lens, (e.g., the fourth Purkinje images). In yet another embodiment, the eye-sensing system 302 could be configured to acquire images of the eye pupil with so-called bright and/or dark pupil images. Depending upon the embodiment, a combination of these glint and pupil imaging techniques may be used for eye tracking at a desired level of robustness. Other imaging and tracking methods are possible.

In some embodiments, the eye-sensing system 302 could sense movements of one or more eyelids. For example, the eye-sensing system 302 could detect an intentional blink of a user of the head-mountable device using one or both eyes. Within the context of this disclosure, a detected intentional blink (and/or multiple intentional blinks) could represent a binary selection.

The movement-sensing system 304 could be configured to provide an HMD position and an HMD orientation to the controller 312.

The gyroscope 320 could be a microelectromechanical system (MEMS) gyroscope, a fiber optic gyroscope, or another type of gyroscope known in the art. The gyroscope 320 may be configured to provide orientation information to the controller 312. The GPS unit 322 could be a receiver that obtains clock and other signals from GPS satellites and may be configured to provide real-time location information to the controller 312. The movement-sensing system 304 could further include an accelerometer 324 configured to provide motion input data to the controller 312. The movement-sensing system 304 could include other sensors, such as a proximity sensor and/or an inertial measurement unit (IMU).

The movement-sensing system 304 could be operable to detect, for instance, movements of the head-mountable device and determine which movements may be binary selections being either an affirmative input or a negative input.

The optical system 306 could include components configured to provide images at a viewing location. The viewing location may correspond to the location of one or both eyes of a wearer of an HMD 300. The components of the optical system 306 could include a display panel 326, a display light source 328, and optics 330. These components may be optically and/or electrically-coupled to one another and may be configured to provide viewable images at a viewing location. As mentioned above, one or two optical systems 306 could be provided in an HMD apparatus. In other words, the HMD wearer could view images in one or both eyes, as provided by one or more optical systems 306. Also, as described above, the optical system(s) 306 could include an opaque display and/or a see-through display, which may allow a view of the real-world environment while providing superimposed images.

Various peripheral devices 308 may be included in the HMD 300 and may serve to provide information to and from a wearer of the HMD 300. In one example, the HMD 300 may include a wireless communication system 334 for wirelessly communicating with one or more devices directly or via a communication network. For example, wireless communication system 334 could use 3G cellular communication, such as CDMA, EVDO, GSM/GPRS, or 4G cellular communication, such as WiMAX or LTE. Alternatively, wireless communication system 334 could communicate with a wireless local area network (WLAN), for example, using WiFi. In some embodiments, wireless communication system 334 could communicate directly with a device, for example, using an infrared link, Bluetooth, or ZigBee. The wireless communication system 334 could interact with devices that may include, for example, components of the HMD 300 and/or externally-located devices.

Although FIG. 3 shows various components of the HMD 300 as being integrated into HMD 300, one or more of these components could be physically separate from HMD 300. For example, the camera 340 could be mounted on the wearer separate from HMD 300. Thus, the HMD 300 could be part of a wearable computing device in the form of separate devices that can be worn on or carried by the wearer. The separate components that make up the wearable computing device could be communicatively coupled together in either a wired or wireless fashion.

### 3. Example Implementations

Several example implementations will now be described herein. It will be understood that there are many ways to implement the devices, systems, and methods disclosed herein. Accordingly, the following examples are not intended to limit the scope of the present disclosure.

### First Example Implementation

### Message Notification

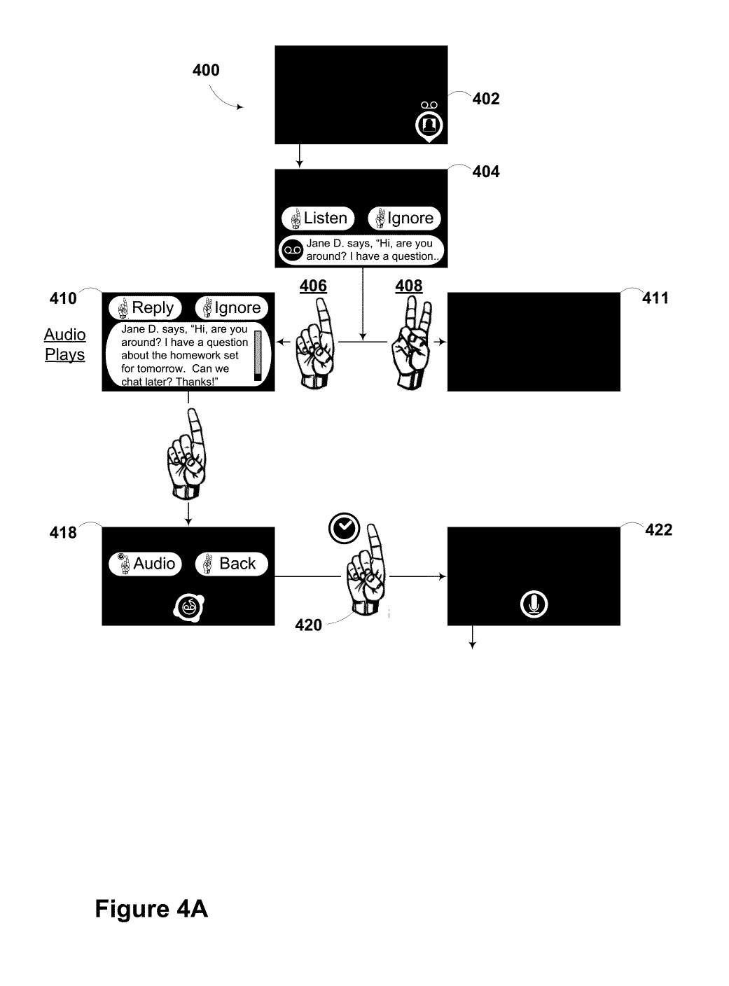

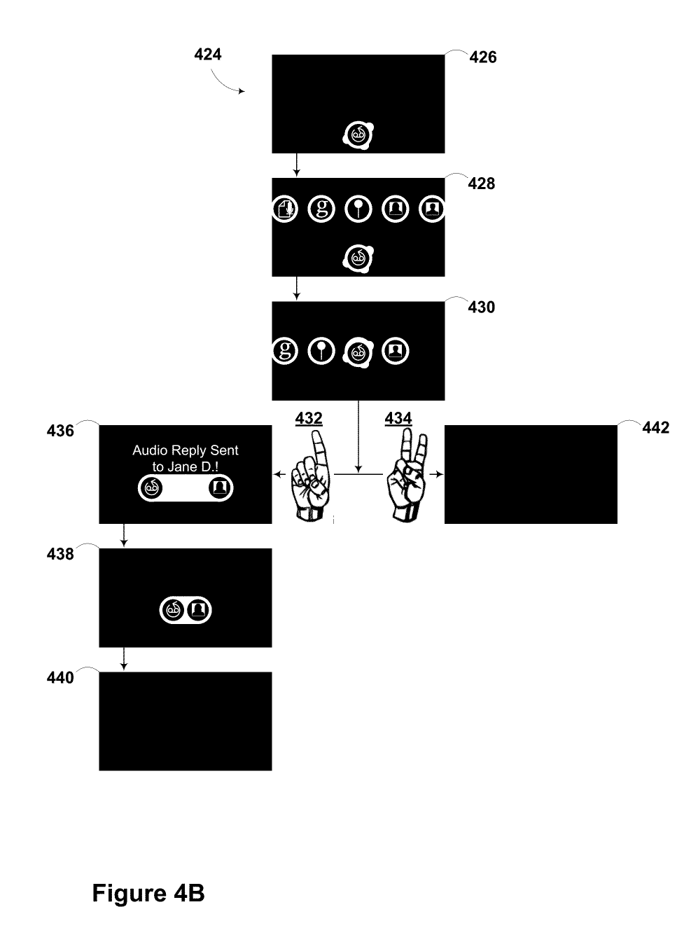

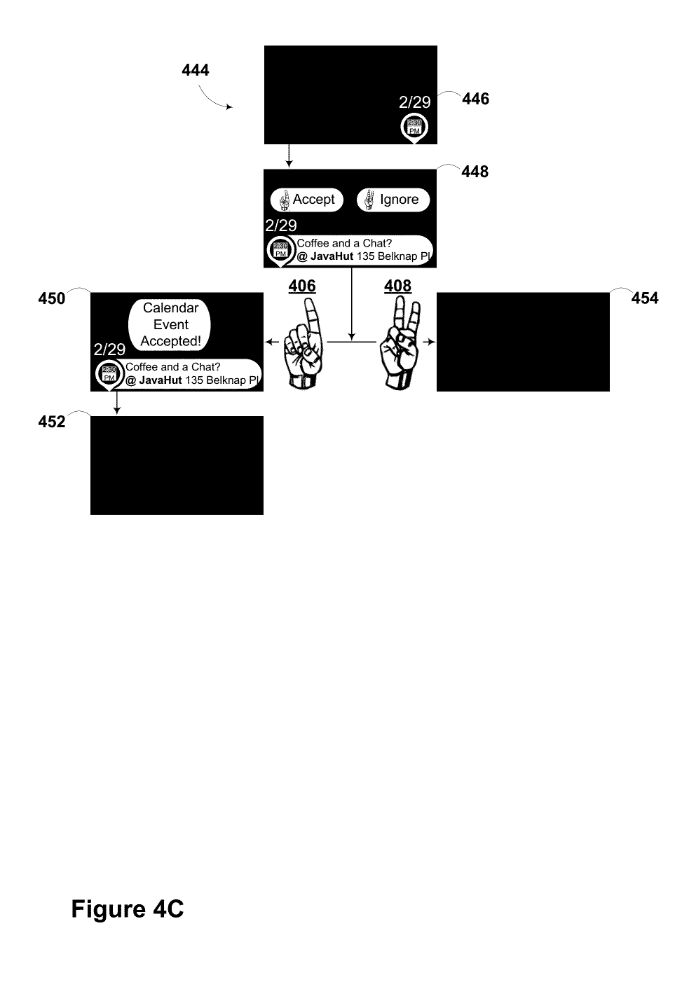

FIG. 4A illustrates a message notification scenario 400 involving an incoming message. In scenario 400, a message notification icon could be displayed on the display of a head-mountable device, as shown in Frame 402. The head-mountable device could be any of the devices shown and described in reference to FIGS. 1A-3. Within the context of FIGS. 4A-B and 5A-G, a black background may indicate a substantially see-through area, while the white elements may indicate graphical images overlaid on a view of the real-world environment.

Frame 402 shows the message notification icon at the bottom right portion of the display. The message notification icon could be any type of graphical representation of any type of incoming message or communication. In one example, the icon could include a small portrait or representation of a source of the message. Further, the message notification icon could identify the type of media included in the message, for instance, in the form of an icon (shown in Frame 402 as an audio recording icon). Different types of message notifications are possible. For instance, message notifications could relate to e-mails, texts, videos, still images, incoming voice calls, or other forms of communication.

Frame 404 includes a short preview of the message notification. In this example, a transcription of the audio message could appear as a text preview. For instance, a bubble of text may appear and the text could include “Jane D. says, ‘Hi, are you around? I have a question . . . ’” Thus, the text may include the sender of the message and a short summary or excerpt from the message.

Additionally, choices could be presented on the display related to a follow-up action. For example, as shown in frame 404, an affirmative input icon could be illustrated with text information about the action that may be carried out. In this case, the affirmative input could be a single-touch interaction with the touchpad of the head-mountable device, and the action could be to play the audio message. A negative input icon could be displayed and could relate to a double-touch interaction with the touchpad of the head-mountable device.

The head-mountable device could receive a binary selection, for instance, from a user of the head-mountable device. The binary selection could include the affirmative input 406 or the negative input 408. In this case, if the head-mountable device detects a single-touch interaction on the touchpad (the affirmative input 406), the action could be carried out (Frame 410). If the head-mountable device detects a double-touch interaction (the negative input 408), the graphical interface may revert to a default state (Frame 411).

The default state (e.g., frame 411) could represent, for instance, removing all graphical elements from the display. Thus, in some embodiments, a default state could be one in which the display of the head-mountable device is substantially see-through and/or transparent. Other default states are possible. For example, a default state could include a few icons around the periphery of the display that could relate to the current operating state of the head-mountable device.

Frame 410 may be displayed, for instance, if a binary selection is detected as being an affirmative input to carry out the ‘Listen’ action. Frame 410 includes playing the audio message and optionally displaying a full-text transcription of the audio message. A scroll bar may be included so a user of the head-mountable device could view the entire text of the message. The entire text of the message could include, “Jane D. says, ‘Hi, are you around? I have a question about the homework set for tomorrow. Can we chat later? Thanks!’” Playing the audio message could include using one or more of a speaker, a bone conduction transducer, or another audio output device associated with the head-mountable device.

Frame 410 could additionally include a binary choice. In this case, the binary choice includes whether to Reply or Ignore the message notification. If a binary selection being a negative input is detected, the head-mountable device may revert to a default state, such as that shown in Frame 411.

Upon detecting the binary selection being an affirmative input, Frame 418 may be displayed so as to, in one example, provide a means of replying. For example, Frame 418 may present the binary choice as being ‘Audio’ or ‘Back’. In such a case, a negative input may result in the graphical interface providing a default state (such as Frame 411) and/or could result in moving ‘back’ to a previous state of the user interaction.

If a press-and-hold touch interaction 420 is detected, an audio recording frame 422 could be displayed. Additionally, a microphone icon could be displayed and an audio recording could be made while the press-and-hold interaction 420 is being detected.

FIG. 4B illustrates a message notification scenario 424 and could be a continuation of the example interaction shown and described in reference to FIG. 4A. The message notification scenario 424 could include a Frame 426. Frame 426 could include, for example, an ‘active’ audio reply icon that may represent that an audio recording has been made and is awaiting final disposition. The ‘active’ audio reply icon could change shape dynamically to indicate that it is the relevant media content that may be dispatched to various recipients. For example, the outer border of the ‘active’ audio reply icon could undulate or wiggle. Other ‘active’ icon types and other shape changing modifications are possible.

In an example embodiment, the head-mountable device could be rotated upwards (e.g., the user may tilt the head-mountable device upwards). In response, a menu could be displayed, as shown in Frame 428. The menu may include graphical icons that represent various actions or dispositions. For instance, the graphical icons in Frame 428 may relate to (from left to right): Audio Note, Internet Search, Geotag, Recipient Jane Doe, and Recipient John Smith. Other triggers could cause the menu to be displayed, such as a button, touchpad, voice, and/or eye gaze interaction.

The menu options could be presented as a set of graphical icons from a static list that does not change. Alternatively, some or all of the set of graphical icons could change based on the situational context in which it is accessed. For instance, since, as shown in Frame 428, an audio recording awaits disposition, the graphical icons could relate to possible dispositions for the audio recording. The possible dispositions could relate to specific actions that could be taken by a controller of the head-mountable device or another computing device. For example, the audio recording could be saved as an audio note, the audio recording could be an input for an internet search, the audio recording could be geotagged, the audio recording could be sent to Jane Doe, or the audio recording could be sent to John Smith. In a contextually different situation, the specific actions and/or the graphical icons may be different.

Frame 430 shows the ‘active’ audio reply icon as substantially spatially aligned with the icon that represents Recipient Jane Doe. Spatial alignment could be achieved by moving the head-mountable device. For example, a user wearing the head-mountable device could turn and tilt the head-mountable device so as to spatially align the ‘active’ audio reply icon with the desired menu option. At this point, the head-mountable device could receive a binary selection from among an affirmative input and a negative input.

In response to a negative input 434, the head-mountable device could revert to a default state, as shown in Frame 442.

In response to an affirmative input 432, the audio reply message could be sent to Jane Doe. Correspondingly, confirmation text could be displayed, such as, “Audio Reply Sent to Jane D.!” Additionally or alternatively, a graphical confirmation notification could be displayed to relate that the requested action has been carried out.

Frame 438 includes the display of graphical icons that may further indicate that the requested action of dispatching the audio reply to Jane Doe has been carried out.

After the text and/or graphical confirmation, a default state could be displayed, such as shown in Frame 440.

FIG. 4C illustrates a message notification scenario 444 involving an incoming calendar event invitation. In scenario 444, a calendar event invitation icon could be displayed on the display of a head-mountable device, as shown in Frame 446. The calendar event invitation icon could include, for example, the date and time of the event. The graphical interface could display further information about the event. For instance, as shown in Frame 448, the event name (Coffee and a Chat?) and the event location (JavaHut 135 Belknap Pl) could be displayed, as shown in Frame 448. Further, the head-mountable device could offer a binary selection choice. In scenario 444, the choice may include accepting the calendar event invitation or ignoring the calendar event invitation.

In response to the affirmative input 406, a confirmation message could be displayed: “Calendar Event Accepted!” as shown in Frame 450. The calendar event could be saved in a calendar associated with a user of the head-mountable device. The graphical interface could then revert to a default state, as shown in Frame 452. In response to the negative input 408, the graphical interface could ignore the event invitation and return to a default state, as shown in 454.

Although FIGS. 4A, 4B, and 4C relate to responses to an incoming audio message, and an incoming calendar event invitation, the methods and systems disclosed herein could also include other types of notifications. Possible other notifications include e-mail messages, text messages, phone calls, and other forms of communication. Furthermore, the possible responses to such notifications could vary widely. For instance, possible responses could include ignoring the notification, saving the notification until later, sending a reply to one or more recipients, forwarding the notification to one or more recipients, etc.

### Second Example Implementation

### Content Creation

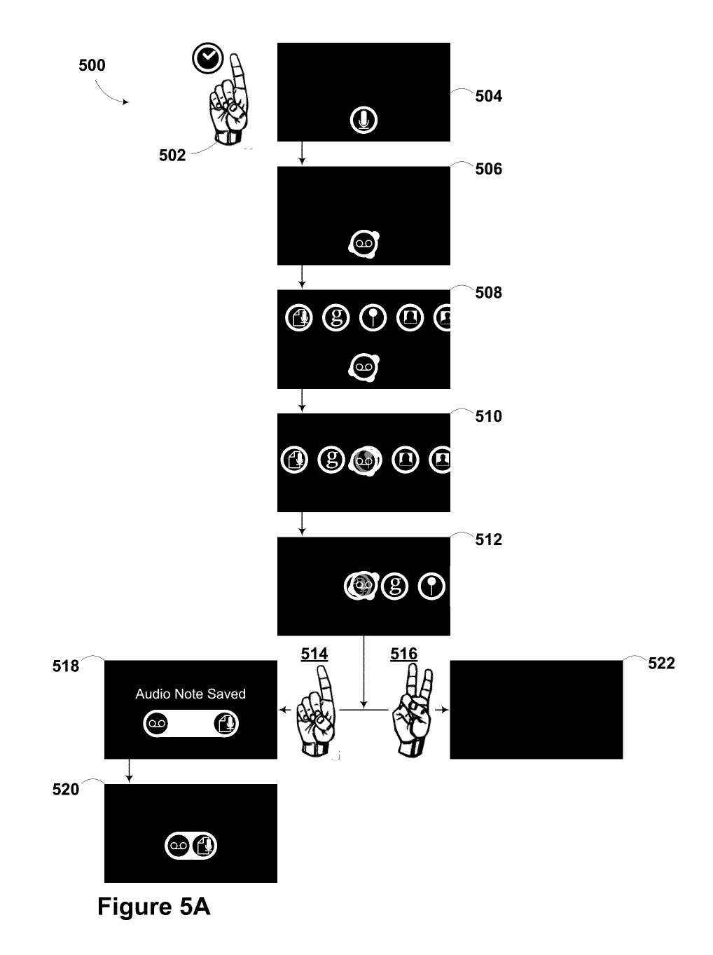

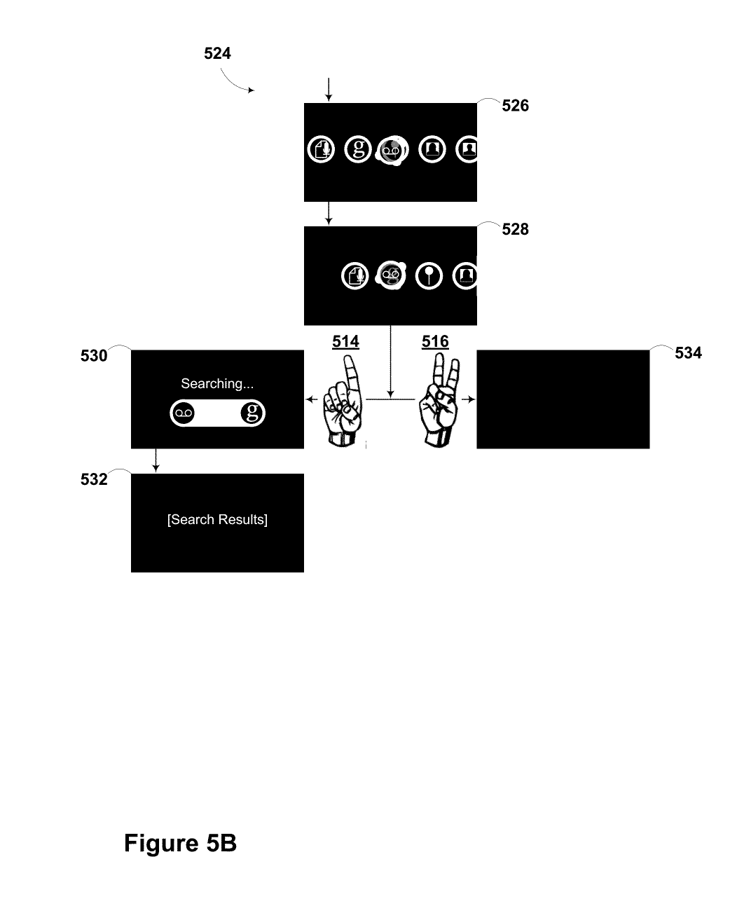

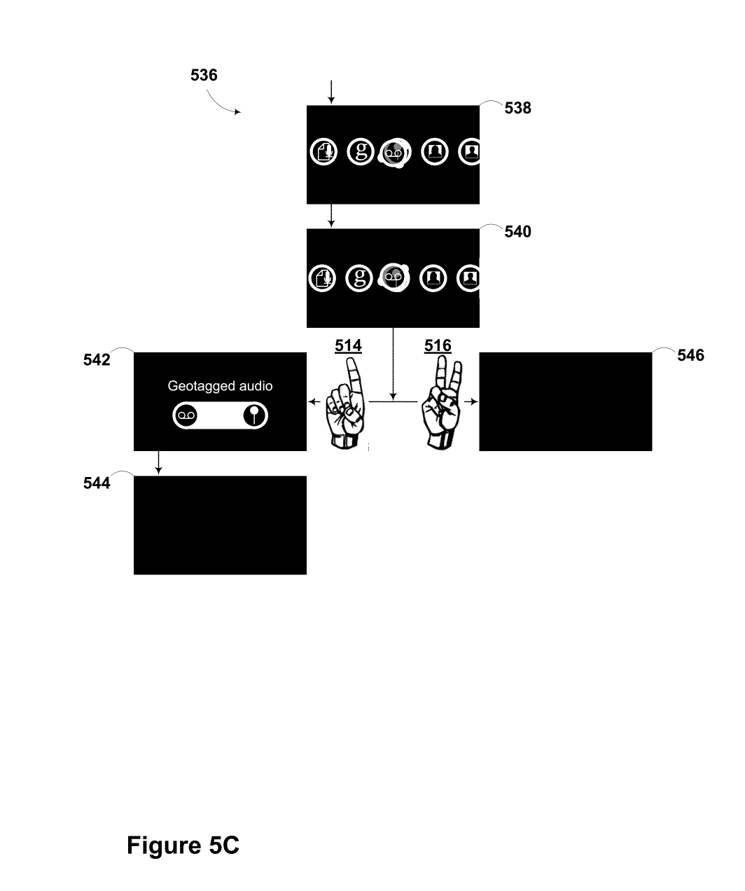

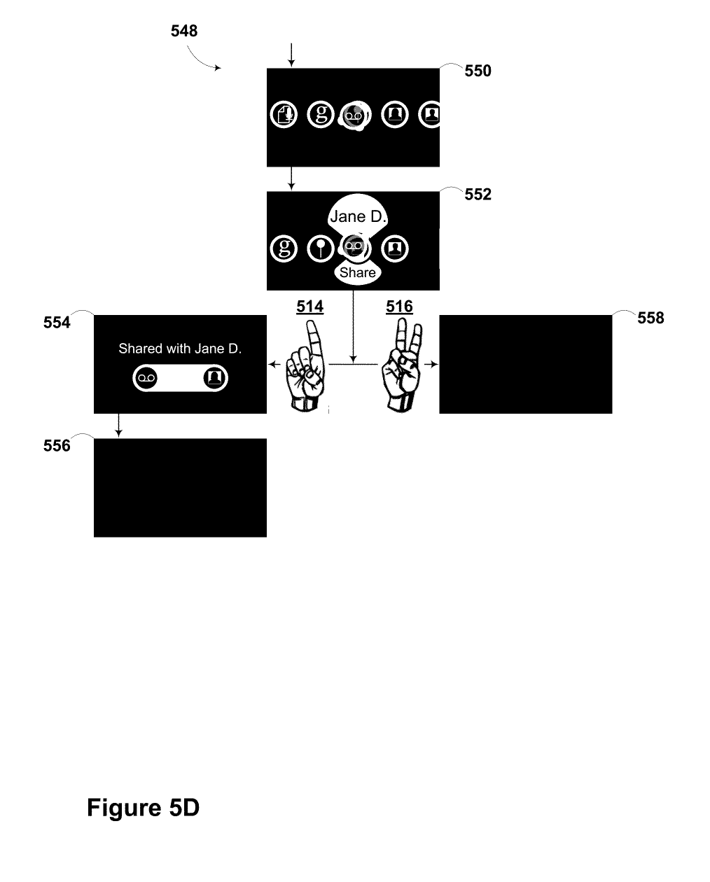

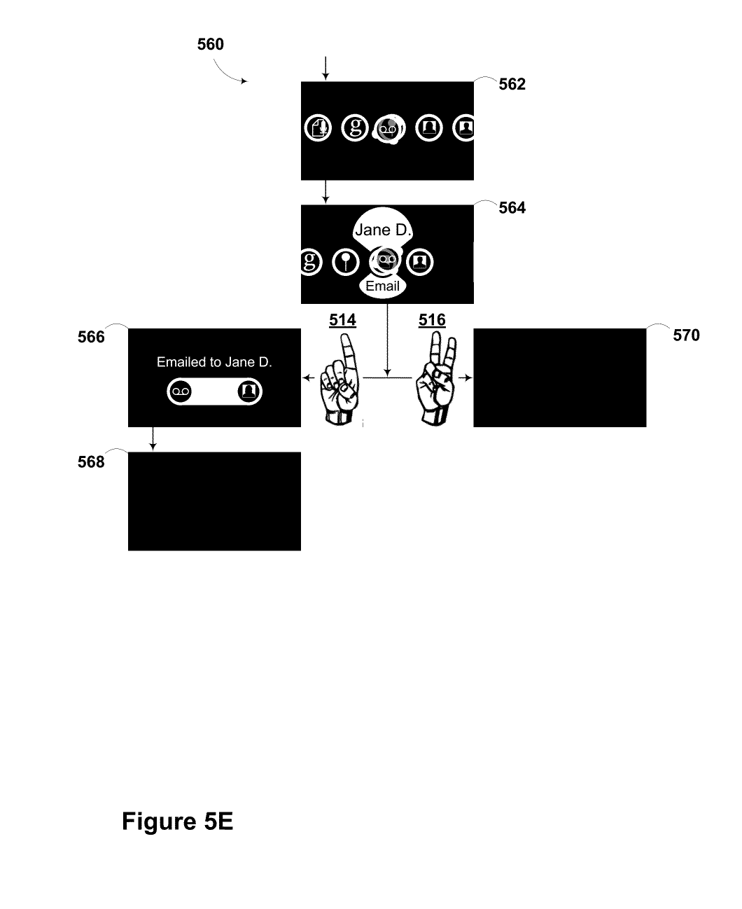

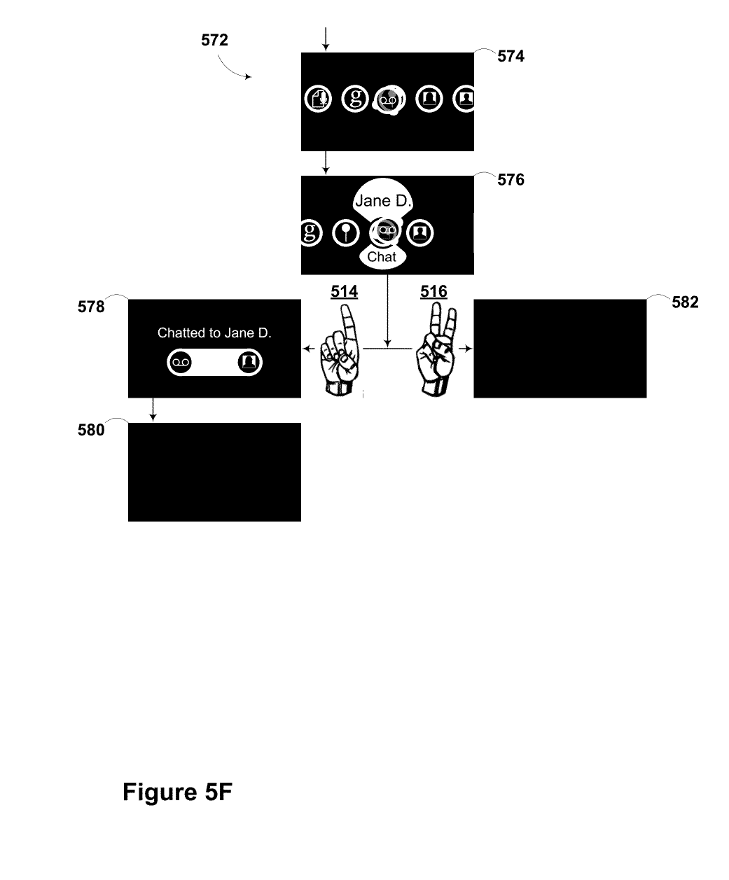

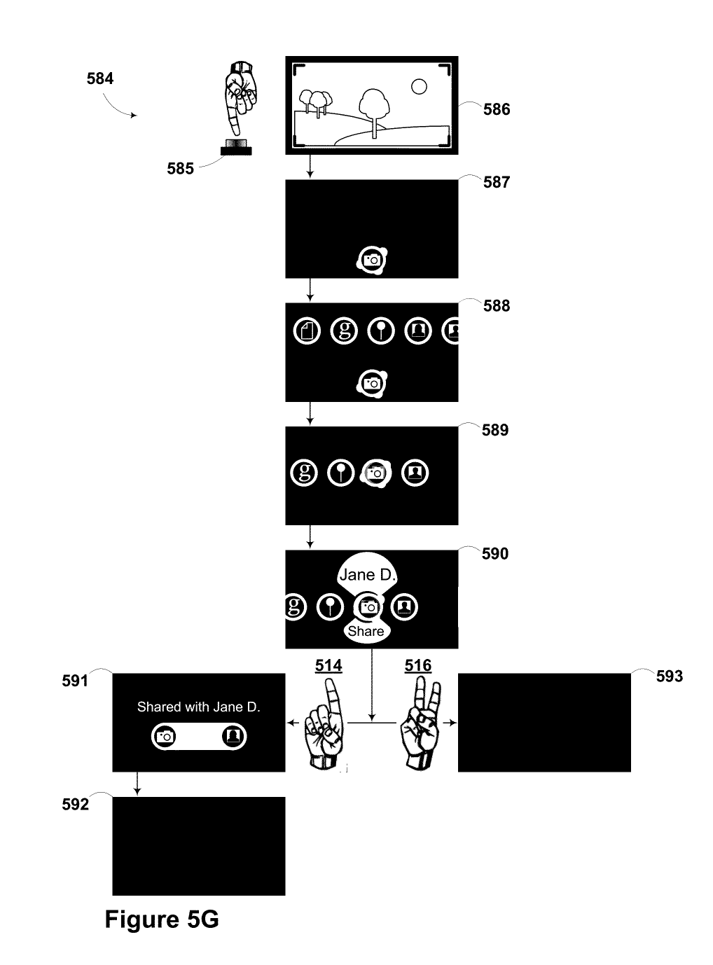

FIG. 5A illustrates a content creation scenario 500. The scenario 500 may include a press-and-hold touch interaction 502. The press-and-hold touch interaction 502 could include a finger pressing on the touchpad of the head-mountable device for at least a predetermined length of time. In some instances, the predetermined length of time could be 500 milliseconds. Other predetermined time lengths are possible.

In response to the press-and-hold touch interaction 502, an audio recording may commence. Frame 504 illustrates a microphone icon that could be displayed while audio is being recorded. When the audio recording is complete, an ‘active’ audio media icon could be displayed as shown in Frame 506. Depending on the embodiment, the ‘active’ audio media icon could change shape dynamically.

Similar to the example described in reference to FIG. 4B, based on a movement of the head-mountable device, a menu could be displayed as shown in Frame 508. Other ways of triggering the display of the menu are possible. By altering the position of the head-mountable device, the ‘active’ audio media icon could be spatially aligned with an icon from the menu, as shown in Frame 512. Frame 512 illustrates an overlap of the ‘active’ audio media icon with the audio note icon. The audio note icon may relate to an action involving saving the audio media as an audio note.

In response to a negative input 516, Frame 522 could be displayed, and the head-mountable device could revert to a default state. Other responses to the negative input 516 are possible. In response to an affirmative input 514, the action of saving the audio media as an audio note could be carried out. For instance, the audio note could be saved as a file, text could confirm the action while stating: “Audio Note Saved,” and graphical icons could be displayed to indicate that the audio media has been saved as an audio note as shown in Frame 518. Frame 520 could represent part of a graphical confirmation that the audio note has been saved.

FIG. 5B illustrates a content creation scenario 524. Scenario 524 includes a menu displayed as shown in Frame 526. The menu could be similar to that displayed in Frame 508 and described in reference to FIG. 5A. In the scenario 524, however, the ‘active’ audio media icon could be spatially aligned with the internet search icon, as shown in Frame 528. In response to the affirmative input 514, text could be displayed: “Searching . . . ” Further, a confirmation involving graphical icons could be displayed, such as illustrated in Frame 530. Search results could be displayed in Frame 532. In response to the negative input 516, Frame 534 could be displayed, which may correspond with a default state of the graphical interface.

FIG. 5C illustrates another content creation scenario 536. Scenario 536 includes a menu displayed as shown in Frame 538. The menu could be similar to that displayed in Frame 508 and described in reference to FIG. 5A. However, in the scenario 536, the ‘active’ audio media icon could be spatially aligned with the geotagging icon, as shown in Frame 540. In response to the affirmative input 514, text confirming the action could be displayed: “Geotagged audio.” Additionally or alternatively, a confirmation involving graphical icons could be displayed, such as illustrated in Frame 542. The graphical interface could revert to a default state following the interaction as shown in Frame 544. Within the context of scenario 536, in response to a negative input 516, Frame 546 could be displayed, and the head-mountable device could revert to a default state.

FIG. 5D also illustrates a content creation scenario 548. Scenario 548 includes a menu displayed as shown in Frame 550. The menu could be similar to that displayed in Frame 508 and described in reference to FIG. 5A. However, in the scenario 548, the ‘active’ audio media icon could be spatially aligned with the Recipient Jane Doe icon, as shown in Frame 552. In response to the spatial alignment of the ‘active’ audio media icon with the Recipient Jane Doe icon, further information and/or options could be displayed. For example, a text identifier: “Jane D.” could be displayed. Additionally or alternatively, a specific communication means could be displayed, such as “Share.” Other forms of communication means could be possible within the context of the instant disclosure. For example, the content may be communicated via a text message, an e-mail, a chat window, and an audio message, among many other possibilities.

Sharing the audio media could include any form of communicating the message to the recipient. In response to the affirmative input 514, text confirming the action could be displayed: “Shared with Jane D.” Additionally or alternatively, a confirmation involving graphical icons could be displayed, such as illustrated in Frame 554. The graphical interface could revert to a default state following the interaction as shown in Frame 556. Within the context of scenario 548, in response to a negative input 516, Frame 558 could be displayed, and the head-mountable device could revert to a default state.

FIG. 5E illustrates another content creation scenario 560. Scenario 560 includes a menu displayed as shown in Frame 562. The menu could be similar to that displayed in Frame 508 and described in reference to FIG. 5A. However, in the scenario 560, the ‘active’ audio media icon could be spatially aligned with the Recipient Jane Doe icon, as shown in Frame 540. Further, additional text and graphical information have indicated that the means of communication is an email message. In such a case, an action could be to attach the audio content to an e-mail message to a particular recipient. In response to the affirmative input 514, the action could be carried out. Further, text confirming the action could be displayed: “Emailed to Jane D.” Additionally or alternatively, a confirmation involving graphical icons could be displayed, such as illustrated in Frame 566. The graphical interface could revert to a default state following the interaction as shown in Frame 568. If the negative input 516 is detected in response to Frame 564, the graphical interface could revert to a default state and display Frame 570.

FIG. 5F additionally illustrates yet another content creation scenario 572. Scenario 572 includes a menu displayed as shown in Frame 574. The menu could be similar to that displayed in Frame 508 and described in reference to FIG. 5A. However, in the scenario 574, the ‘active’ audio media icon could be spatially aligned with the Recipient Jane Doe icon, as shown in Frame 576. Further, additional text and graphical information have indicated that the means of communication is a chat message. In such a case, an action could be to attach the audio content to an open chat session with the selected recipient. In response to a negative input, the graphical interface may revert to a default state, such as illustrated in Frame 582.

In response to the affirmative input 514, the selected action could be carried out by opening a chat session with the recipient and sending the audio content as an initial communication. Further, text confirming the action could be displayed: “Chatted to Jane D.” Additionally or alternatively, a confirmation involving graphical icons could be displayed, such as illustrated in Frame 578. The graphical interface could revert to a default state following the interaction as shown in Frame 580. In response to the negative input 516, the graphical interface may revert to a default state. Correspondingly, Frame 582 could be displayed.

FIG. 5G illustrates a content creation scenario 584. In particular, the scenario 584 includes a photo button interaction 585 and describes the process to create image content. In the scenario 584, the head-mountable device could include a photo button operable to initiate the capture of an image. A user of the head-mountable device could initiate the photo button interaction 585 by pressing the photo button with a finger. Alternatively, image capture could be triggered using other means. For example, image capture could be triggered with a voice command, a touchpad interaction, an eye blink, or any other input means recognizable using the apparatus and method disclosed herein.

Although scenario 584 describes the creation of a still image, video images could be created as well. For instance, if a press-and-hold touch interaction is detected with the photo button, video may be captured instead of a still image.

Upon detecting a photo button interaction 585, an image may be captured, for instance, using a camera associated with the head-mountable device. Accordingly, a representation of the captured image may be displayed on the display of the head-mountable device, as shown in Frame 586. The image content could become an ‘active’ image media content icon as illustrated in Frame 587. Further, as shown in Frame 588, the ‘active’ image media content icon could be displayed among a set of menu items in order to select how the image will be dispatched. The menu items could include icons that relate to various actions the head-mountable device may undertake to dispatch the image. For example, the actions could include saving the captured image, using the image as an input to an internet search, geotagging the image, and sending the image to a recipient.

Within the context of scenario 584, the ‘active’ image media content icon could be spatially aligned with a Recipient Jane D. icon based on, for instance, detected movements of the head-mountable device. In response to the affirmative input 514, the image content could be shared with Jane D. (e.g., via an e-mail, short messaging service (SMS), or another communication means). Upon sharing the image, a confirmation message could be displayed: “Shared with Jane D.” and a graphical confirmation icon could be displayed, as shown in Frame 591. Following the interaction, the graphical interface could revert to a default state, such as that shown in Frame 592. If a negative input 516 is detected in response to Frame 590, the graphical interface could revert to a default state, as shown in Frame 593.

Other menu choices could be selected in scenario 584. For instance, selection of other menu choices could include carrying out various actions associated with the graphical icons in the menu similar to those described above in FIG. 5A-F. Thus, the captured image could be saved, used as a search input, geotagged, shared, e-mailed, etc.

Additionally, multiple forms of content could be combined in an outgoing message/share. For example, upon capturing the image, a press-and-hold touch interaction could trigger an audio recording that could be associated with the image. The combination of the image and the audio recording could be dispatched in any of the aforementioned ways. Other actions that involve combined content (e.g., audio/visual content, audio/textual content, visual/textual content) are possible within the context of this disclosure.

### 4. Example Methods

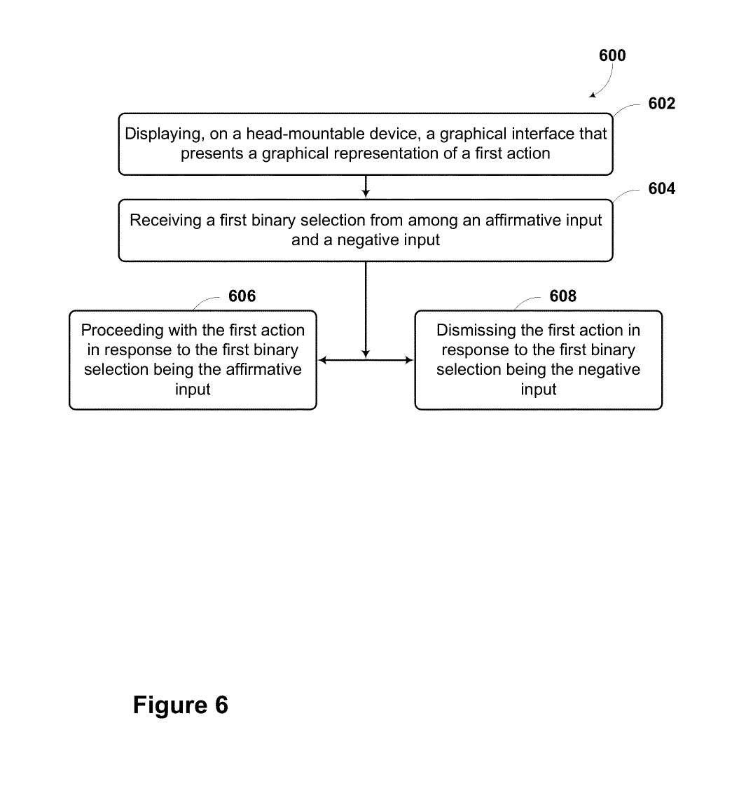

A method 600 is provided for displaying, using a head-mountable device, a graphical interface and graphical representation of an action. In response to a binary selection being an affirmative or negative input, the action could proceed or be dismissed, respectively. Depending upon the embodiment, the action could relate to at least one of a contact, a contact's avatar, a media file, a digital file, a notification, and an incoming communication. The method could be performed using any of the devices shown in FIGS. 1A-3 and described above, however, other configurations could be used. FIG. 6 illustrates the steps in an example method, however, it is understood that in other embodiments, the steps may appear in different order and steps could be added or subtracted.

Step 602 includes displaying, on the head-mountable device, a graphical interface that presents a graphical representation of a first action. In some embodiments, the first action could relate to at least one of a contact, a contact's avatar, a media file, a digital file, a notification, and an incoming communication. The first action could be represented by a graphical icon displayed via the graphical interface. The first action could relate to a menu item that is selected using the head-mountable device. The selection of the menu item could involve detecting a movement of the head-mountable device.

The graphical interface could be displayed on the head-mountable device using a transparent, translucent, or opaque display. The head-mountable device could include at least one display. The at least one display could be a liquid-crystal display (LCD) or be a liquid-crystal on silicon (LCOS) display. Alternatively or additionally, the graphical interface could be displayed on the head-mountable device using a projection technique. Other methods to display the graphical interface on the head-mountable device are possible.

Within the context of the disclosure, the first action could relate to a variety of different things. In one embodiment, the first action could relate to a contact or a contact's avatar. That is, the first action could select a particular contact or contact's avatar from a contact list. A contact's avatar could represent, for instance, a graphical representation of a contact (e.g., a picture of the contact or a picture that represents the contact).

The first action could alternatively or additionally relate to a media file. The media file could be a media file that is created, saved, transmitted, and/or received using the head-mountable device. The media file could also be stored or located elsewhere. Media files could include, for instance, an audio file, an image file, or a video file. Other types of media files are possible and contemplated herein.

In other embodiments, the first action could relate to a digital file. The digital file could be any file that is created, saved, transmitted, and/or received using the head-mountable device. Alternatively, the digital file could be stored or located elsewhere. Digital files could include a document, a spreadsheet, a data file, or a directory. Other types of digital files are possible.

The first action could also or alternatively relate to a notification. For example, notifications could include location-based alerts, alarms, reminders, message notifications, calendar notifications, etc. Other notifications types are possible as well.

The first action could alternatively relate to an incoming communication. The incoming communication could represent a phone call, a video call, a chat, an e-mail, a text, or any other form of one-way, two-way, and/or multi-party communications.

Step 604 includes receiving a first binary selection from among an affirmative input and a negative input. The first binary selection could be received by the head-mountable device directly or by another computing system, such as a server network. The first binary selection could include a ‘yes’ or a ‘no’ preference, which may relate to the affirmative input and the negative inputs, respectively.

A possible affirmative input could include a single-touch interaction on a touchpad of the head-mountable device. The single-touch interaction could include a single fingertip applying pressure to the touchpad for a brief period of time (e.g., less than 500 milliseconds in duration). A possible negative input could include a double-touch interaction of the touchpad. The double-touch interaction could include the application of two fingertips simultaneously on the touchpad for the brief period of time.

Other touchpad interactions are possible. For instance, the first binary selection could include detecting at least one of a single-touch interaction within a predetermined area on the touchpad. In such case, an affirmative input could be distinguished from a negative input based upon the spatial location of the single-touch interaction on the touchpad.

Other forms of affirmative inputs and negative inputs are possible. For example, swipe interactions on the touchpad could be interpreted by the controller or by another computing system as binary selections. For example, a swipe in one direction (e.g., towards the front) could be an affirmative input and a swipe in another direction (e.g., towards the rear) could be a negative input.

In some embodiments, two trackpads could be used within the context of the disclosed method. For instance, trackpads could be located along each side of the head-mountable device (e.g., mounted on each earpiece). In such an instance, a user may provide an affirmative input or a negative input by touching one of the two trackpads (e.g., right trackpad touch=affirmative input, left trackpad touch=negative input). Other ways to utilize multiple trackpads are possible.

In other embodiments, the head-mountable device could include an eye-sensing system. The eye-sensing system could be configured to detect various actions related to a motion of at least one eye, such as a single blink, a double blink, a gaze axis associated with the graphical representation of the first action, a leftward gaze axis, a rightward gaze axis, an upward gaze axis, a downward gaze axis, and a staring gaze. Other eye motions could be recognized by the eye-sensing system. For example, a left- or right-eye wink could be possible affirmative and/or negative inputs. The various eye-sensing actions could further make up the first binary selection and various eye-sensing actions could represent affirmative inputs and/or negative inputs.

The head-mountable device could optionally include a movement-sensing system. In such an example embodiment, the first binary selection could be detected using the movement-sensing system. The first binary selection could include at least one of a rotation of the head-mountable device about a substantially horizontal axis, a rotation of the head-mountable device about a substantially vertical axis, and a pointing axis of the head-mountable device. The pointing axis of the head-mountable device could include an axis that extends perpendicularly outward from the front of the head-mountable device.

The head-mountable device could also be configured to sense gestures. For example, a forward-facing camera could capture images of a field of view in front of the head-mountable device. A user of the head-mountable device could use gestures to provide an affirmative input and/or a negative input. Possible gestures could include a thumb(s)-upward gesture, a thumb(s)-downward gesture, holding various fingers up or down or left or right, and sign language. In other embodiments, gestures may include waving an arm in a particular direction or any other dynamic motion. Gestures could also include a user pointing with an arm and/or a finger at an object in the real-world environment or a graphical object (e.g., an icon) as displayed by the head-mountable device.

The head-mountable device could additionally or alternatively include a microphone configured to receive the first binary selection. In such a case, the first binary selection could include a voice command and/or a predetermined sound.

An affirmative input and/or a negative input could include any combination of a gesture movement, an eye movement, and/or any other means of input described herein. For example, an eye-sensing system could sense that a user of the head-mountable device is looking at a given displayed graphical icon from among a set of icons. The given icon could be associated with an action. A gesture movement (e.g., a thumb-upward gesture) could then provide an affirmative input associated with the action. Other combinations of input means are possible to form affirmative inputs and/or negative inputs in response to a binary selection related to an action.

Step 606 includes proceeding with the first action in response to the first binary selection being the affirmative input. Proceeding with the first action could include any step or set of steps taken to carry out the first action. For instance, proceeding with the first action could include, but should not be limited to, creating an audio recording, capturing an image, selecting a menu item from a set of menu items, dispatching audio/video/text content to a contact, saving content, creating a calendar event, inviting a contact to communicate via chat or other means. Other ways to proceed with the first action are possible within the scope of this disclosure.

Step 608 includes dismissing the first action in response to the first binary selection being the negative input. Dismissing the first action could include returning the graphical interface to a default state (e.g., display nothing). Alternatively, dismissing the first action could include move ‘back’ a step in a series of interactions with the graphical interface. Other ways of dismissing the first action are possible.

In some embodiments, after proceeding with the first action, a graphical interface could be displayed that presents a graphical representation of a second action. In such embodiments, a second binary selection could be received from among the affirmative input and the negative input. Based on the second binary selection, the method could include proceeding with the second action in response to an affirmative input and dismissing the second action in response to a negative input. In other words, successive graphical representations of actions could be displayed via the graphical interface of the head-mountable device. A user of the head-mountable device could provide affirmative inputs and/or negative inputs in response to the graphical representations. In response to the affirmative and/or negative inputs, the respective actions could be carried out or dismissed based on the given binary selection.

The method could further include receiving an audio recording instruction. The audio recording instruction could include detecting a press-and-hold interaction on the touchpad. The press-and-hold interaction may include a touch interaction on the touchpad that lasts for a predetermined period of time. In such a case, a possible predetermined period of time could be 500 milliseconds. Other predetermined periods of time could be used.

The method could additionally include receiving an image capture instruction. For example, the head-mountable device could include a camera configured to capture a captured image. The head-mountable device could also include a camera button operable, at least in part, to trigger the camera to capture the captured image. In such an example embodiment, receiving the image capture instruction could include detecting an interaction (e.g., a touch interaction) with the camera button of the head-mountable device. Other methods involving image capture using a camera and a camera button are possible.

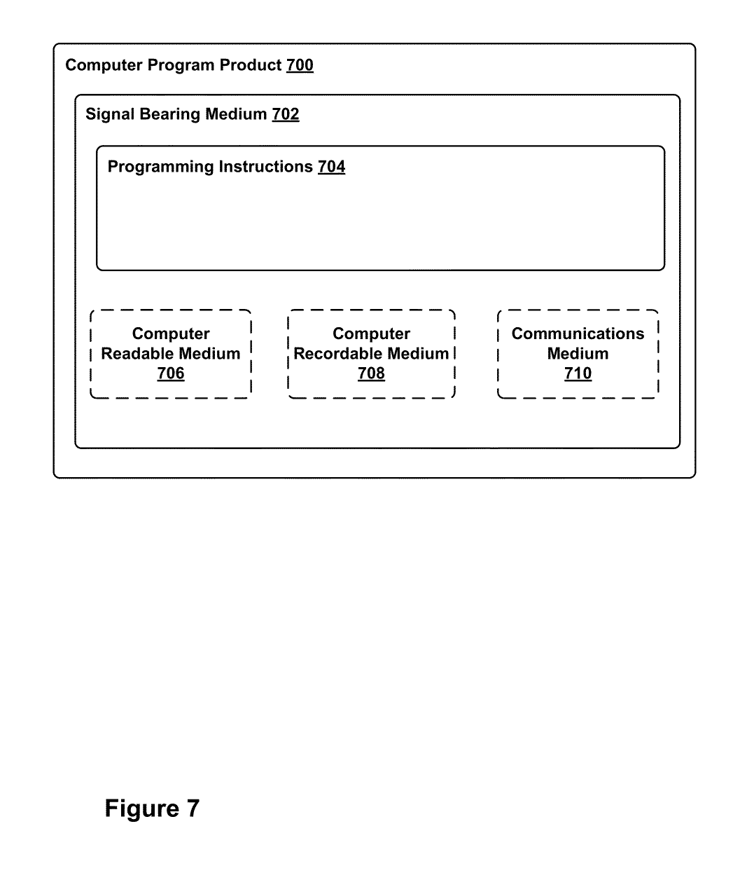

In some embodiments, the disclosed methods may be implemented as computer program instructions encoded on a non-transitory computer-readable storage media in a machine-readable format, or on other non-transitory media or articles of manufacture. FIG. 7 is a schematic illustrating a conceptual partial view of an example computer program product that includes a computer program for executing a computer process on a computing device, arranged according to at least some embodiments presented herein.

In one embodiment, the example computer program product 700 is provided using a signal bearing medium 702. The signal bearing medium 702 may include one or more programming instructions 704 that, when executed by one or more processors may provide functionality or portions of the functionality described above with respect to FIGS. 1A-6. In some examples, the signal bearing medium 702 may encompass a computer-readable medium 706, such as, but not limited to, a hard disk drive, a Compact Disc (CD), a Digital Video Disk (DVD), a digital tape, memory, etc. In some implementations, the signal bearing medium 702 may encompass a computer recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the signal bearing medium 702 may be conveyed by a wireless form of the communications medium 710.

The one or more programming instructions 704 may be, for example, computer executable and/or logic implemented instructions. In some examples, a computing device such as the controller 312 of FIG. 3 may be configured to provide various operations, functions, or actions in response to the programming instructions 704 conveyed to the controller 312 by one or more of the computer readable medium 706, the computer recordable medium 708, and/or the communications medium 710.

The non-transitory computer readable medium could also be distributed among multiple data storage elements, which could be remotely located from each other. The computing device that executes some or all of the stored instructions could be a mobile device, such as the head-mountable device 300 illustrated in FIG. 3. Alternatively, the computing device that executes some or all of the stored instructions could be another computing device, such as a server.

The above detailed description describes various features and functions of the disclosed systems, devices, and methods with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
initially displaying, on a head-mountable device, a graphical interface that presents a default state;
determining a first action based on a predetermined situational context, wherein the first action relates to at least one of a contact, a contact's avatar, a media file, a digital file, a notification, or an incoming communication, and wherein the predetermined situational context comprises at least one of a notification scenario or a content creation scenario;
in response to determining the first action, presenting a graphical representation of the first action via the graphical interface, wherein the head-mountable device comprises one or more touchpads;
receiving a first binary selection from among an affirmative input and a negative input, wherein the affirmative input comprises a first type of interaction with the one or more touchpads and the negative input comprises a second type of interaction with the one or more touchpads;
proceeding with the first action in response to the first binary selection being the affirmative input; and
dismissing the first action and presenting the default state via the graphical interface in response to the first binary selection being the negative input.

2. The method of claim 1, further comprising:
after proceeding with the first action, displaying a graphical interface that presents a graphical representation of a second action;
receiving a second binary selection from among the affirmative input and the negative input, wherein the affirmative input comprises the first type of interaction with the one or more touchpads and the negative input comprises the second type of interaction with the one or more touchpads;
proceeding with the second action in response to the second binary selection being the affirmative input; and
dismissing the second action in response to the second binary selection being the negative input.

3. The method of claim 1, wherein displaying the graphical interface comprises displaying a graphical icon associated with the first action.

4. The method of claim 1, wherein the first type of interaction with the one or more touchpads is a single-touch interaction with the one or more touchpads.

5. The method of claim 1, wherein the second type of interaction with one or more touchpads is a double-touch interaction with the one or more touchpads.

6. The method of claim 1, further comprising selecting a menu item from among a plurality of menu items using the head-mountable device, wherein the first action relates to the selected menu item.

7. The method of claim 6, wherein selecting the menu item comprises detecting a movement of the head-mountable device.

8. (canceled)

9. (canceled)

10. (canceled)

11. (canceled)

12. The method of claim 14, wherein the head-mountable device comprises a microphone, wherein the microphone is configured to capture audio for the audio recording.

13. The method of claim 12, further comprising receiving an audio recording instruction, wherein receiving the audio recording instruction comprises detecting a press-and-hold interaction on the one or more touchpads, wherein the press-and-hold interaction comprises a touch interaction that lasts for a predetermined length of time.

14. The method of claim 1, wherein the media file comprises at least one of an audio recording, an image, and a video.

15. The method of claim 14, wherein the head-mountable device comprises a camera, and wherein the camera is configured to capture the image.

16. The method of claim 15, further comprising receiving an image capture instruction, wherein receiving the image capture instruction comprises detecting an interaction with a camera button of the head-mountable device.

17. A head-mountable device, comprising:
a display configured to initially display a graphical interface that presents a default state, wherein the head-mountable device comprises one or more touchpads; and
a controller configured to:
a) determine an action based on a predetermined situational context, wherein the action relates to at least one of a contact, a contact's avatar, a media file, a digital file, a notification, and an incoming communication, and wherein the predetermined situational context comprises at least one of a notification scenario or a content creation scenario;
b) in response to determining the action, present a graphical representation of the action via the graphical interface;
c) receive a binary selection from among an affirmative input and a negative input, wherein the affirmative input comprises a first type of interaction with the one or more touchpads and the negative input comprises a second type of interaction with the one or more touchpads;
d) proceed with the action in response to the binary selection being the affirmative input; and
e) dismiss the action and present the default state via the graphical interface in response to the binary selection being the negative input.

18. The head-mountable device of claim 17, wherein the graphical representation comprises a graphical icon associated with the action.

19. The head-mountable device of claim 17, wherein the first type of interaction with the one or more touchpads is a single-touch interaction with the one or more touchpads.

20. The head-mountable device of claim 17, wherein the second type of interaction with the one or more touchpads is a double-touch interaction with the one or more touchpads.

21. (canceled)

22. (canceled)

23. (canceled)

24. (canceled)

25. The head-mountable device of claim 27 further comprising a microphone, wherein the microphone is configured to capture audio for the audio recording.

26. The head-mountable device of claim 25, wherein the controller is further configured to detect an audio recording instruction, wherein the audio recording instruction comprises a press-and-hold interaction on the one or more touchpads, wherein the press-and-hold interaction comprises a touch interaction that lasts for a predetermined length of time.

27. The head-mountable device of claim 17, wherein the media file comprises at least one of an audio recording, an image, and a video.

28. The head-mountable device of claim 27 further comprising a camera, wherein the camera is configured to capture the image.

29. The head-mountable device of claim 28 further comprising a camera button, wherein the controller is further configured to detect an image capture instruction, wherein the image capture instruction comprises an interaction with the camera button.

30. A non-transitory computer readable medium having stored therein instructions executable by a computer system to cause the computer system to perform operations comprising:
initially displaying, on a head-mountable device, a graphical interface that presents a default state;
determining an action based on a predetermined situational context, wherein the action relates to at least one of a contact, a contact's avatar, a media file, a digital file, a notification, or an incoming communication, and wherein the predetermined situational context comprises at least one of a notification scenario or a content creation scenario;
in response to determining the action, presenting a graphical representation of the action via the graphical interface, wherein the head-mountable device comprises one or more touchpads;
receiving a binary selection from among an affirmative input and a negative input, wherein the affirmative input comprises a first type of interaction with the one or more touchpads and the negative input comprises a second type of interaction with the one or more touchpads;
proceeding with the action in response to the binary selection being the affirmative input; and
dismissing the action and presenting the default state via the graphical interface in response to the binary selection being the negative input.

31. The non-transitory computer readable medium of claim 30, wherein the first type of interaction with the one or more touchpads is a single-touch interaction with the one or more touchpads.

32. The non-transitory computer readable medium of claim 30, wherein the second type of interaction with the one or more touchpads is a double-touch interaction with the one or more touchpads.
